(19) United States
(12) Patent Application Publication
(10) Pub. No.: US 2004/0249853 A1
(43) Pub. Date: Dec. 9, 2004

(54) Late bound subscription based event dispatching system and method

(75) Inventors: Shy Cohen, Bellevue, WA (US); Samuel D. Clement, Kirkland, WA (US)

Correspondence Address: SHOOK, HARDY & BACON L.L.P., 2555 GRAND BOULEVARD, KANSAS CITY, MO, 64108-2613, US

(73) Assignee: Microsoft Corporation

(21) Appl. No.: 10/455,199

(22) Filed: Jun. 5, 2003

(51) Int. Cl. G06F 7/00

(52) U.S. Cl. 707/103 R

(57) ABSTRACT

Embodiments of the present invention provide a system and method for use in a computing environment to manage event registration and create and fire events. The system includes a memory structure wherein event types are associated with event identifications (ID). The system further includes a module that is operable to retrieve an event identification (ID) from the memory structure when the event's ID is requested by either an event-consumer or an event-producer and a module to register an event type if the event type is not found in the memory structure. Additional modules are operable to create event objects, to attach an event-consumer to and detach from an event type, and to fire an event object. According to the method, when the system receives a request for an event's ID, it will search the memory structure. If the event type is registered within the memory structure, the system will return the event ID to the requesting object. If the event type is not registered within the memory structure, the system will register the event type thereby associating an event ID with the event type and return the event ID to the requesting object. When the system receives a request to create an event type, it will create an appropriate event type. Conversely, when requested, the system will delete an event type. In addition, the system will attach or detach an event-consumer from an event type when such a request is received. Finally, the system will notify event-consumers that an event object of the type they registered for has fired.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to computing environments. More particularly, embodiments of the present invention encompass a system and method for providing a name-based event system wherein an event-consumer can register for an event of a certain type before the event-producer exists. The present invention also allows multiple event-consumers to register for an event type that could be produced by a number of different event-producers.

### BACKGROUND OF THE INVENTION

Object-oriented programming languages are widespread in the computer programming field. Many popular operating systems and software tools provide an environment that supports object-oriented programming, including the Windows family of operating systems and Windows applications from the Microsoft Corporation in Redmond, Washington. Under this paradigm, a programmer creates an object to perform a function. In general, an object is a self-contained entity that is characterized by a recognizable set of attributes and behaviors. Put another way, an object is an encapsulated module of code and related data which is externally accessible through well-defined and controlled connection points. An object has properties, which are settings that can be checked and changed. An object will perform an action when requested; the action is referred to as a method. Importantly, an object may respond to and produce events. By providing a collection of objects, the programmer may not only provide customized functions within an existing software tool but also may create useful, efficient applications.

An event represents something that happens to an object and it is something to which an object can respond with a predetermined action. An object that produces an event is referred to as an event-producer, a source or a publisher. An object that receives an event is referred to as an event-consumer, a sink or a subscriber. Other terms are also used. Examples of events include moving or clicking a mouse, pressing a key, opening or closing a document, and pushing a button. Part of an object's definition includes specifying the event or event types that the object will produce.

Clearly, the operating environment in which an object exists must provide rules and/or means for communicating the occurrence of an event to the object. In one model, the environment requires that an event-consumer register with the event-producer. Thereafter, when the event of interest occurs, the event-producer will notify the event-consumer of the event. Other environments include an event-dispatching mechanism. In these environments, event-producers will register with the event-dispatching mechanism to inform the mechanism of the type of event or events the event-producers will produce. Event-consumers will also register with the event-dispatching mechanism to determine the event or events that may be reported by the system. If the event type sought by a particular event-consumer is registered with the event-dispatching mechanism, the event-consumer will request that it be notified when the event occurs. Thereafter, when an event occurs, the event-producer will notify the event-dispatching mechanism, and the mechanism will then route the event to the event-consumers that have registered to receive the event.

Both of these approaches have a common limitation: the event-producer must exist before the event-consumer can register for its events. In the first type of environment, obviously, if the event-producer does not exist, then the event-consumer will not find the event-producer when it seeks to register for the event. In the second type of environment, if an event-producer does not exist, then it cannot register with the event-dispatching mechanism so that when the event-consumer registers with the event-dispatching mechanism, it will not find the event or events sought among the registered events. In both cases, the event-consumer is forced to periodically poll either the environment or the event-dispatching mechanism to determine if an event-producer is present. Unfortunately, the periodic poll requirement increases the size and complexity of the event-consumer. In addition, periodic polling may be unpractical in systems that dynamically load and unload components since it may miss events which were produced by objects which existed only in between polls. Thus, a system and method are needed in which an event-consumer can register for.an event before the event-producer exists.

An additional problem exists with current environments. Specifically, it is common for several instances of a particular event-producer to exist at any given time. It is also common that several different event-producers may produce the same type of event. Unfortunately, current environments are limited in that they only allow events of a certain type to be produced by a single source. Thus, there is no mechanism for an event-consumer to easily receive a particular event from a number of different event-producers that might produce that type of event.

### BRIEF SUMMARY OF THE INVENTION

Embodiments of the present invention provide a system and method for use in a computing environment to manage event registration and to create and fire events. The system defines two categories of events: private events are events produced by a particular object instance and public events are events that may be generated by any object. Every event in the system is assigned a name, and public events also are assigned a name space. Name spaces assist in scoping the event name. Private events do not need explicit scoping since they are implicitly scoped to the object that produces them. The system includes a memory structure wherein event names are associated with event identifications. The system further includes a module that is operable to retrieve an event identification (ID) from the memory structure when the event's ID is requested. The event ID for private events can only be obtained from the object who registered it, and the system ensures this privacy by not providing a mechanism to search for them, whereas the ID of public events can be obtained from the system. If the event ID is not found within the memory structure when it is requested, then a module will register the event as a public event. Additional modules are operable to create event objects, to delete private event types, to link or attach an event-consumer to an event type so that the event-consumer will be notified when an event of this type fires, to disconnect or detach an event-consumer from an event type, and to fire an event.

According to the method, when the system receives a request for an event type's ID, it will search the memory structure. If the event type is registered within the memory structure, the system will return the event type's ID to the requesting object. The requesting object may be either an event-consumer or an event-producer. If the event type is not registered within the memory structure, the system will register the event type thereby associating an event ID with the event type and return the event ID to the requesting object. When the system receives a request to create an event of a certain type, it will create an appropriate event object.

Conversely, when requested, the system will delete an event type. In addition, the system will attach or detach an event-consumer from an event type when such a request is received. Finally, the system will notify event-consumers when an event object of a type for which they registered has fired.

The above described system and method provide a name-based event system in which either an event-producer or an event-consumer may register an event type. With this capacity, objects no longer are required to poll either the system or an event-dispatching mechanism until an event-producer is present or registered. The present invention also provides that objects requesting an ID for an event type will receive the same ID regardless of whether the requesting object is an event-consumer or event-producer. Thus, multiple event consumers may register for an event type that could be produced by a number of different event producers. Use of this invention will allow flexible management of objects and/or components, lower memory requirements while simplifying the programming model, and make the writing of applications simpler.

### BRIEF DESCRIPTION OF THE SEVERAL VIEWS OF THE DRAWING

Embodiments of the present invention are described in detail below with reference to the attached drawings figures, wherein:

FIG. 1 is directed to an exemplary computing environment in which the present invention can be practiced;

FIG. 2 is a block diagram illustrating one embodiment of the present invention; and

FIG. 3 is a UML sequence diagram showing a possible sequence of events to depict the operation of the present invention.

### DETAILED DESCRIPTION OF THE INVENTION

Embodiments of the present invention provide a system and method for use in a computing environment to manage event registration and to create and fire events. The system and method are operable to provide a name-based event system in which either an event-producer or an event-consumer may register an event type. In addition, the present invention allows multiple event consumers to register for an event type that could be produced by a number of different event producers.

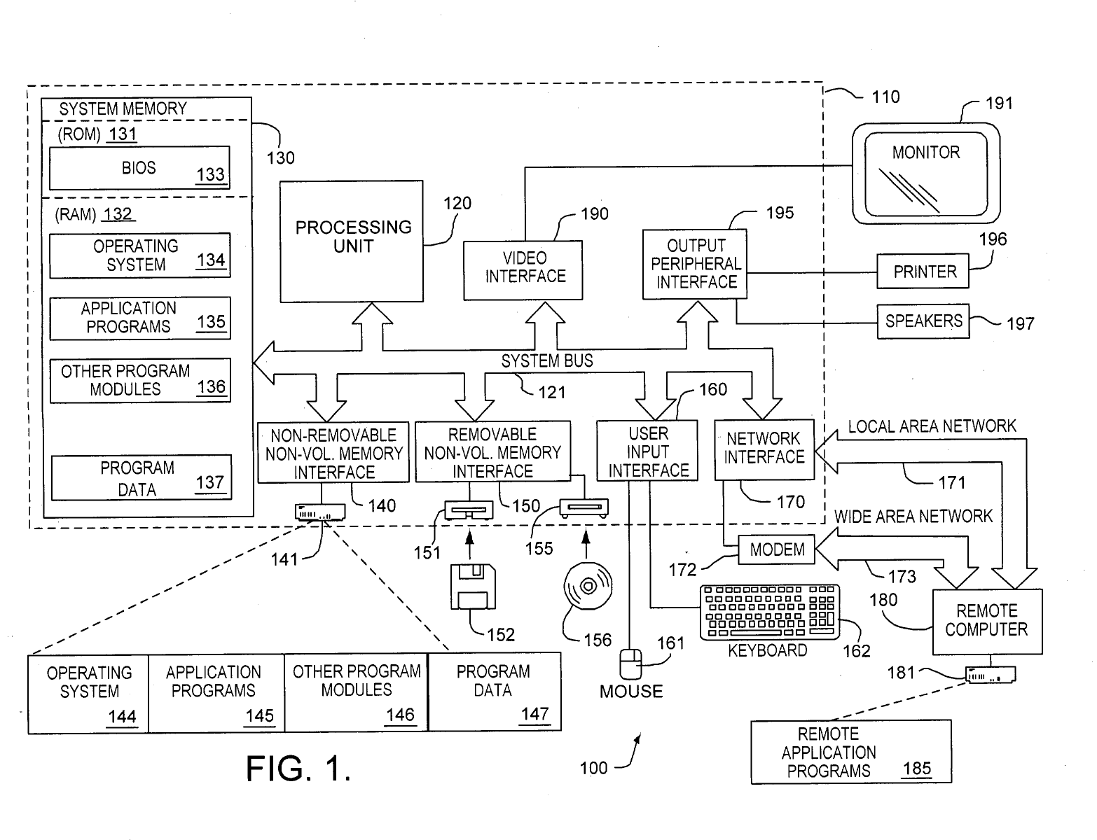

Having briefly provided an overview of the present invention, an embodiment of the invention will be discussed with reference to FIGS. 1-3. An exemplary operating environment for the present invention is described below.

### Exemplary Operating Environment

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. The LAN and WAN can be wired, wireless, or some combination thereof.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

### Object Model Terminology

Briefly, in an object model, a “class” defines the kind of characteristics, or properties, a particular type of object will possess, the methods by which these properties can be manipulated and the methods describing the operations the object may perform. Each individual object in the model is frequently referred to as an “instance” of its class or an instance of an object of its class. Different instances of an object can exist in the same runtime environment and each is uniquely identified. The terms “object” and “instance of an object” are used interchangeably in the present application and the distinction will be clear to one skilled in the art based on the context in which the term is used. A property that provides access to an object is often referred to as an accessor function.

An object contains “methods” or processes that the object performs on its data fields, usually in response to a message directed toward it. In addition to properties and methods, which are basically internal to an object, objects in an interactive run-time environment must react to outside actions such as when a user creates a new object by “dragging and dropping” an instance of the object into the environment. This action causes the object to broadcast a response to the action that notifies other objects that it has been created. This response is termed an “event” and the object is said to have “fired” the event. Objects can monitor the run-time environment for events to learn of new objects added to the object model.

The Component Object Model (COM) is a model used for object-oriented programming. COM specifies how objects interact and communicate within a single application, a distributed application or between applications (e.g., client/server applications) by defining a set of standard interfaces and mechanisms to register and discover others. Object interfaces are groupings of semantically related functions through which a client application accesses the services of a server application.

The COM is one model that defines an architecture for building objects and, in particular, defines the polymorphism between objects. COM is currently used extensively and its details are well known to those skilled in the art. COM also forms a constituent portion of the Object Linking and Embedding (OLE) environment of object-based services. OLE's framework and flexibility is also well understood by those skilled in the art. Currently, COM provides for certain communications and operations between objects, and objects used in a COM environment must conform to the COM definitions and rules. The present invention was developed utilizing COM although it is not limited to this model.

### Exemplary Embodiment of the Invention

According to an embodiment, the system and method of the present invention are implemented as instructions that can be performed or executed on a computer. As stated above, the present invention defines two categories of events: private events are events produced by a particular object instance and public events are events that may be generated by any object.

Private events allow the system to be used in a manner similar to the traditional one, in which the event consumer needs to register with the event producer. In an embodiment, every event type in the system is assigned a name, and public event types are also assigned a name space. The system includes a memory structure wherein an event type is associated with an event identification (ID). This memory structure may be a table, database or other suitable structure.

Registration of event-producers, event types and event consumers may be done declaratively or programmatically. Declarative specification of event-producers, event types and event consumers is performed at startup when a “rules” file is read and processed. It should be understood that when the system processes the rules file, it will initiate any needed component or object to create the event-producer, event type and event consumer objects and to register the event types within the memory structure. Programmatic specification of event-producers, event types and event consumers is done through the system object model as described below.

When an object is first loaded and registered with the system it will invoke a “startup” method. This method provides the object with the system object model, and the object may keep a reference to the model that can be used in all of its instances. Whenever a new instance of an object is created, an “initialize instance” method is invoked to coordinate resources common to each instance of the object. To unload an object, an “unload” method is invoked. This method releases any resources the object is currently using. A “shutdown” method causes the object to release any reference to the system, including the object model.

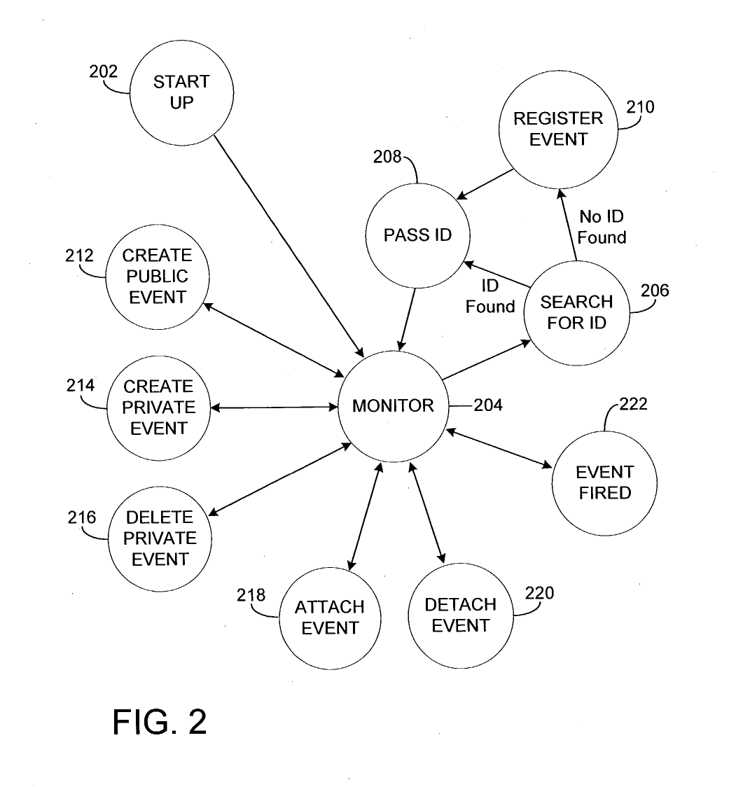

Referring now to FIG. 2, at start up 202 the rules file is read and processed so that the event-producer, event type and event consumer objects specified therein are created and the event types are registered within the memory structure. After this task is complete, the system enters into a monitoring state 204 wherein it awaits notification of certain events.

The system includes a method for managing event type registration. When an object seeks to create or attach to an event type, it requests the event's ID by name which invokes the “event registration” method. A COM implementation of the interface for this method may be:

HRESULT getEventCookie ([in] BSTR type,

```
  [in]  BSTR name,
  [out, retval] DWORD *pdwCookie)
```

(It should be understood that an ID that is a runtime property and is often referred to as a “cookie.”) Thereafter, the system conducts a search 206 of the memory structure using the event type's name. If the ID is found, it is passed 208 to the requesting object. If the ID is not found, then the event type is registered 210 within the memory structure and an ID is associated with the event type name. After the event type is registered at 210, the ID is passed 208 to the requesting object. After passing the ID, the system returns to its monitoring state 204.

The system also includes a method for an event-producer to create a public event type. The COM interface for this method may be:

| | |
|---|---|
| HRESULT createEvent ( | [in] DWORD cookie, |
| | [out, retval] eventInterface, *ppEvent); |

where “eventInterface” is an interface that allows an event-producer to set the event's properties and fire the event. In invoking this method, the event-producer passes the event ID to the system, and the system will create 212 an event object associated with the event ID. As stated, in the course of creating the event object, the method implements an event interface which allows the event-producer to set the event's properties, or configure the event, and fire the event. The interface also allows event-consumers to query the event object's properties. After creating the event object, the system returns to its monitoring state 204.

Somewhat similarly, the system includes a method for an event-producer to create a private event type. The COM interface for this method may be

| | |
|---|---|
| HRESULT createPrivateEvent ( | [in] BSTR name, |
| | [out, retval] DWORD, *pdwCookie) |

It should be understood that private event types, which are also referred to as transient event types, are produced for the use of particular event-consumers. Therefore, the event-producer is required to manage the lifetime of the event type and enable the event-consumers to register for that event type. Thus, for this type of event, the event-producer may keep a table associating event names and cookies. The event-producer will invoke the system's “create private event” method 214 and pass the event name. The system will register the event, form the event object as described above, and return the event ID to the event-producer. Thereafter, the event-producer may pass the event ID to the event-consumers found in its table, who will then be able to attach to the event as usual. After completing the “create private event type” method, the system returns to its monitoring state 204.

The system includes a method to delete a private event type. The COM interface for this method may be

HRESULT deletePrivateEvent ([in] DWORD cookie)

When an event-producer desires to delete a private event type, it will invoke this method 216 and pass the event ID. The method destroys the event type identified with the event ID. After completing this method, the system returns to its monitoring state 204.

The “attach event” method 218 is used by an event-consumer to inform the system that it should receive notification when a particular event type is fired. The COM interface to this method may be

| | |
|---|---|
| HRESULT attachEvent ( | [in] DWORD cookie, |
| | [in] IUnknown **ppunkConsumer) |

This method is invoked by passing the event ID and event-consumer's identity. The method 218 registers the event-consumer in the list of objects that are to receive notifications of events of the type associated with the specified event ID and then return to its monitoring state 204.

When an event-consumer no longer wants to receive notice when a particular event type is fired, it will invoke the “detach event” method 220. The COM interface for this method may be

| | |
|---|---|
| HRESULT detachEvent ( | [in] DWORD cookie, |
| | [in] IUnknown **ppunkConsumer) |

Similar to the invocation for the attach event method, the event consumer will pass the event ID and event-consumer's identity. The method 220 will find the event-consumer in the system's lists and remove the event-consumer's identification and then return to its monitoring state 204.

The system also includes a method to notify the system that an event has fired. This method is invoked by an event-producer object when it wishes to fire the event object. The COM interface for this method may be

HRESULT fire ( )

The method 222 will refer to the list of event-consumers who have attached the particular event type and send notice to those event-consumers that the event has fired. Thereafter, the system returns to its monitoring state 204. It should be understood that once an event object has fired, it can be placed into a state where no more attributes may be added to the event and the current attributes are set to read-only mode.

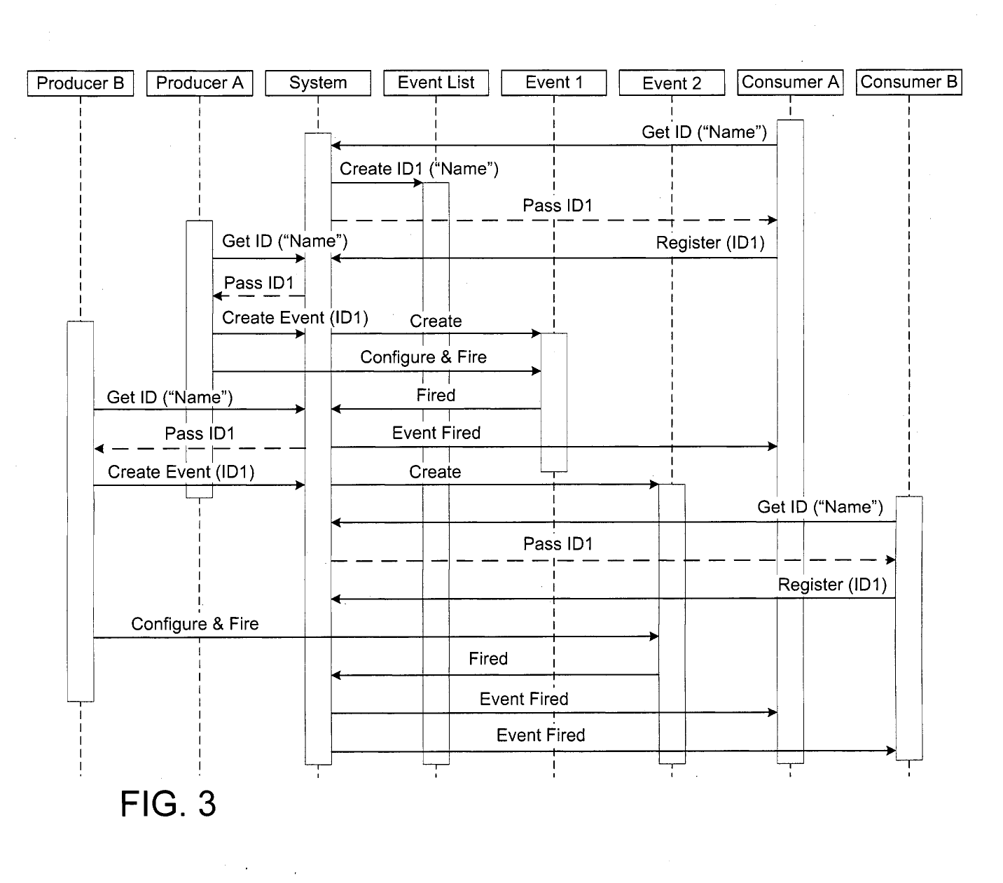

FIG. 3 shows a Universal Markup Language (UML) sequence that illustrates how an event type is created, how an actual event instance is created, and how the consumers are notified of the event. It should be understood that this illustration is not intended to display the entire operability of the present invention. Instead, only selected portions of the operability are shown in order to provide a sense of the flexibility and power of the invention.

In this example of the operation of this embodiment of the present invention, the first action is Consumer A requesting an event ID from the System for the event type “name.” When the system sees no entries in Event List, it creates ID1 for event type “name” and stores that association in Event List. The system then passes ID1 back to Consumer A. Note that when Consumer A requested the event ID for the event type “name,” no event-producers existed. Despite this fact, the System created an entry in the memory structure for the event type and provided Consumer A with an event ID.

After receiving ID1 for the event type “name,” Consumer A requests that the System register, or attach, it to the event type so that Consumer A will receive notice that the event type has fired. As stated above, when the System receives this request, it places Consumer A within a notification list (or database, or table, etc.) for the ID1 event type.

Continuing with FIG. 3, at approximately the same time as Consumer A requested registration for event type ID1, Producer A requested an event ID for the event type “name.” After checking with the Event List, the System returns ID1 to Producer A as the event type's ID. Producer A then requests that the System create an event object for the event type identified by ID1. The System complies and creates the Event1 object.

Producer A is now free to set the properties of the Event1 object and to fire the object directly, which occurs next in FIG. 3. When it receives the fire command, the event object notifies the System instead of individual event-consumers. The System, in turn, notifies the event-consumers that have registered to receive notice that the event type identified by ID1 has fired. In this example, only Consumer A has registered, and the System sends an “event fired” message to Consumer A.

Thereafter, Producer B requests an event ID for the event type “name.” After checking with event list, the System returns ID1 to Producer B as the event type's ID. Producer A then requests that the System create an event object for the event identified by ID1, and the system complies creating a second instance of the event (Event 2).

At this time, Consumer B also requests an event ID for the event type “name.” After receiving ID1 from the System, Consumer B requests that the System register, or attach, it to the event type identified by ID1 so that it will receive notice when an event of this type has fired.

Continuing with FIG. 3, the next action shown is Producer B configuring and firing Event 2. As with Event 1, when Event 2 receives the fire command it immediately notifies the System. The System again checks its list to determine the event-consumers that are registered to receive notice that an event type identified by ID1 has fired. This time the system finds that both Consumer A and Consumer B are registered and sends both an “event fired” notice.

As mentioned above, FIG. 3 shows that the present invention allows an event-consumer to register for an event type even before the event-producer exists. FIG. 3 also illustrates that the present invention allows multiple event-producers to fire “same-type” events and that multiple event-consumers may receive notice of the firings. As shown and discussed, consumer A received an “event fired” notice when both Event 1 and Event 2 were fired even though Producer A directed Event 1 to fire and Producer B directed Event 2 to fire.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain the ends and objects set forth above, together with other advantages, which are apparent and inherent to the system and method. It will be understood that certain features and sub-combinations are of utility and may be employed without reference to other features and sub-combinations. This is contemplated and within the scope of the appended claims.

What is claimed is:

1. A method in a computing environment that supports object-oriented programming for managing event registration and distribution, said environment including event-producers and event-consumers, said event-producers operable to fire events, said event-consumers operable to receive events, said events each having a name, said method comprising:
creating a first memory structure for storing associated event names and event identifications;
receiving a request for an event's identification;
searching said first memory structure for said event type by name; and
if said event type is found within said first memory structure, returning the event identification associated with said event type;
wherein said request may originate from either an event-consumer or an event-producer.

2. The method of claim 1 further comprising:
if said event type is not found within said first memory structure, associating an event identification and an event name with said event type, placing said event name and said event identification within said memory structure, and returning said event identification.

3. The method of claim 1 further comprising:
receiving a request to create an event object referred to by said event identification; and
creating said event object.

4. The method of claim 1 further comprising:
receiving a request to delete the event type referred to by said event identification; and
deleting said event type.

5. The method of claim 1 further comprising:
receiving a request to attach an event-consumer to an event type referred to by an event identification; and
entering said event-consumer into a second memory structure, said second memory structure containing event-consumers to be notified when said event type fires.

6. The method of claim 5 further comprising:
receiving a request to detach an event-consumer from an event type referred to by an event identification; and
removing said event-consumer from said second memory structure.

7. The method of claim 5 further comprising:
receiving notice that an event object of a certain type has fired; and
notifying the event consumers in said second memory structure associated with said event type.

8. A computer readable medium containing computer-useable instructions embodied thereon for causing a computer to perform a method in a computing environment that supports object-oriented programming for managing event registration and distribution, said environment including event-producers and event-consumers, said event-producers operable to fire events, said event-consumers operable to receive events, said events each having a name, and an identification, the method comprising:
creating a first memory structure for storing associated event names and event identifications;
receiving a request for an event's identification;
searching said first memory structure for said event type by name; and
if said event type is not found within said memory structure, associating an event identification with said event type, placing said event name and said event identification within said memory structure, and returning said event identification;
wherein said request may originate from either an event-consumer or an event-producer.

9. The computer-readable medium of claim 8 wherein said method further comprises:
if said event type is found within said first memory structure, returning the event identification associated with said event.

10. The computer-readable medium of claim 8 wherein said method further comprises:
receiving a request to create an event object referred to by said event identification; and
creating said event object.

11. The computer-readable medium of claim 8 wherein said method further comprises:
receiving a request to delete an event type referred to by an event identification; and
deleting said event type.

12. The computer-readable medium of claim 8 wherein said method further comprises:
receiving a request to attach an event-consumer to an event type referred to by an event identification; and
entering said event-consumer into a second memory structure, said second memory structure containing event-consumers to be notified when said event type fires.

13. The computer-readable medium of claim 12 wherein said method further comprises:
receiving a request to detach an event-consumer from an event type referred to by an event identification; and
removing said event-consumer from said second memory structure.

14. The computer-readable medium of claim 12 wherein said method further comprises:
receiving notice that an event object of a certain type has fired; and
notifying the event consumers in said second memory structure associated with said event type.

15. A system in a computing environment that supports object-oriented programming for managing event registration and distribution, said environment including event-producers and event-consumers, said event-producers operable to fire events, said event-consumers operable to receive events, said events each having a name, said system comprising:
a first memory structure operable to store an event name and associated event identification; and
an event registration module operable to receive a request for an event's associated identification, search said first memory structure for said event and return said event identification if said event is found;
wherein said request may originate from either an event-consumer or an event-producer.

16. The system of claim 15 wherein said event registration module is further operable to associate an event identification with said event's name, place said event's name and said event identification within said first memory structure, and return said event identification if said event is not found within said first memory structure.

17. The system of claim 15 further comprising a create event module operable to receive a request to create an event object referred to by said event identification and to create said event object.

18. The system of claim 15 further comprising a delete event module operable to receive a request to delete an event object referred to by an event identification and to delete said event object.

19. The system of claim 15 further comprising a attach event module operable to receive a request to attach an event-consumer to an event type referred to by an event identification and to enter said event-consumer into a second memory structure, said second memory structure containing event-consumers to be notified when said event type fires.

20. The system of claim 19 further comprising a detach event module operable to receive a request to detach an event-consumer from an event type referred to by an event identification and to remove said event-consumer from said second memory structure.

21. The system of claim 19 further comprising an event fired module operable to receive notice that an event object of a certain type has fired and to notify the event consumers in said second memory structure associated with said event type.
